(19) United States
(12) Patent Application Publication
(10) Pub. No.: US 2014/0004819 A1
(43) Pub. Date: Jan. 2, 2014

(54) Method And Apparatus For Providing Telephone Service

(71) Applicant: Kenneth W. Brent, Murphy, TX (US)

(72) Inventor: Kenneth W. Brent, Murphy, TX (US)

(73) Assignee: Alcatel-Lucent USA Inc., Murray Hill, NJ (US)

(21) Appl. No.: 13/536,476

(22) Filed: Jun. 28, 2012

(51) Int. Cl. H04W 4/24; H04W 4/00; H04W 12/06; H04W 88/02

(52) U.S. Cl. 455/406; 455/550.1; 455/575.1; 455/422.1; 455/411

(57) ABSTRACT

A telephony kiosk and method of providing communications services using a telephony kiosk. A preferred telephony kiosk includes a cabinet on which are mounted a user interface and an operator interface, as well as a number of handsets. The handsets preferably include a minimal number of components so that they cost less than fully-functional personal communications devices and to provide a disincentive for theft. Inside the cabinet in this embodiment is an RF module containing a plurality of RF chains that each including a transceiver for sending and receiving communications between one or more handset and a communications network (or networks). A handset manager bridges the handset cord to the RF module. The kiosk is preferably portable.

### TECHNICAL FIELD

The present invention relates generally to the field of communication devices, and, more particularly, to a method and apparatus for providing telephone service to a plurality of subscribers in a non-traditional environment.

### BACKGROUND

The following abbreviations are herewith defined, at least some of which are referred to within the following description of the state-of-the-art and the present invention.

### BBP Baseband Processor

### CM Control Module

### HM Handset Manager

### HS Handset

### RF Radio Frequency

### TXVR Transceiver

Telephony communications in a traditional environment typically involve personal communication devices that are owned by individual subscribers or, in some cases, leased long term by network providers. Subscribers communicate using these devices by connecting to an existing communications network such a PSTN (public-switched telephone network) or PLMN (public land mobile network). The PSTN usually involves a wireline connection from the network to the subscriber's residence or place of business. In a PLMN a network of antennas connected to the network define cells in which subscribers may communicate by establishing a short-range radio (RF) connection with one or more antennae.

In non-traditional environments, many consumers may not have the means to subscribe to a traditional network. Perhaps the cost of the personal communications device is beyond their means or the network infrastructure is not adequate to accommodate their use even if the devices are affordable. A developing country would be one example, a remote construction project another. In other situations people may not be permitted to carry their own personal communications devices, for example for security reasons. There may also be a legitimate reason for wanting to more closely monitor communications by members of a given population.

Accordingly, there has been and still is a need to address the aforementioned shortcomings and other shortcomings associated with communicating in non-traditional environments. Whatever the reason, there may still be a desire to enables users to communicate with others through a communications network in these and similar situations. These needs and others are answered by embodiments of the present invention, disclosed herein.

Note that the techniques or schemes described herein as existing or possible are presented as background for the present invention, but no admission is made thereby that these techniques and schemes were heretofore commercialized or known to others besides the inventor.

### SUMMARY

The present invention is directed to a manner of providing a telephony station, or kiosk, to permit the offering of effective communications services in a non-traditional environment. In one aspect, the present invention provides a telephony kiosk including an RF (radio frequency) module that has a plurality of RF chains with each RF chain including a transceiver for modulating a signal received from a handset that has been associated with the RF chain and a controller for controlling the operation of the RF module. In this aspect, the kiosk may also include combiner for combining modulated signals from more than one RF chain of the plurality of RF chains for transmission using a single antenna and an antenna communicating with the combiner. A handset manager for connecting to one or more handsets and bridging communications between a respective handset and an associated RF chain may also be present for selectively bridging the communications between a handset and an RF chain as directed by the controller.

In some embodiments, the kiosk further includes a plurality of handsets for assigning to users for requested communication sessions. The kiosk in this aspect also typically includes an on-site memory device for storing, among other things, control programs for execution by the controller. An accounting module may be one such control program, which may be used for recording session start and end times and creating billing records.

In another aspect, the present invention is a telephony kiosk including a plurality of handsets, an RF module comprising a plurality of RF chains, each RF chain including a transceiver for modulating a signal received from a handset of the plurality of handsets, a handset manager for associating a handset of the plurality of handsets with an RF chain of the RF module, and a controller for directing the RF module. The controller may also direct the association of RF chains with handsets for a particular communication session.

In some embodiments of this aspect, the telephony kiosk may also include at least one antenna in communication with the RF module for transmitting and receiving RF communications. In some cases there may be more that one antenna as well. If there is more than one antenna, each may be used for reaching a different communications network, or simply to enable the use of more handsets and RF chains with the kiosk.

In some embodiments of this aspect of the present invention, the kiosk may include a user interface or an operator interface or both. These components may be mounted in or on a cabinet for convenience and security. The cabinet may be used to house any of the kiosk components, and it is preferred that the handsets, which are normally used outside of the kiosk cabinet, are nonetheless secured to it with a cord that includes a coaxial cable of carrying handset-cabinet communications.

In another aspect, the present invention, is a method of providing telephony services to the user of a telephony kiosk, including assigning a handset, usually one of a plurality of handsets, bridging communications to and from the handset to an RF chain in an RF module of the kiosk, and transmitting communications from the handset to a communications network as an RF signal. Note that assigning a handset may consist solely of permitting user to use a handset they have selected. An authorization protocol may be executed prior to assigning the handset to the user, which may include determining whether the user is a subscriber or negotiating terms of payment such as a cash payment or credit card.

In some embodiments, the handset may be normally in a no or low-power state and be powered up for use, for example when the user has been authorized. The method may also include selecting an RF chain from a plurality of RF chains in the RF module for associating with the handset. The selection may be random or based on the type of call. It may also be based on other factors such as the best available frequency or on the maintenance status of the RF chains. The method may also include creating a billing record for the use of the handset by the user.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is an elevation view illustrating a telephony kiosk 100 according to an embodiment of the present invention;

FIG. 2 is a simplified schematic diagram illustrating selected components of a telephony kiosk 200 according to an embodiment of the present invention;

FIG. 3 is a simplified schematic diagram illustrating selected components of an RF module 300 according to an embodiment of the present invention;

FIG. 4 illustrates an exemplary view of a touch screen 400 for monitoring the status of selected components according to an embodiment of the present invention;

FIG. 5 is a block diagram illustrating selected components of an integrated kiosk module 500 according to an embodiment of the present invention; and

FIG. 6 is a flow diagram illustrating a method 600 according to an embodiment of the present invention.

### DETAILED DESCRIPTION

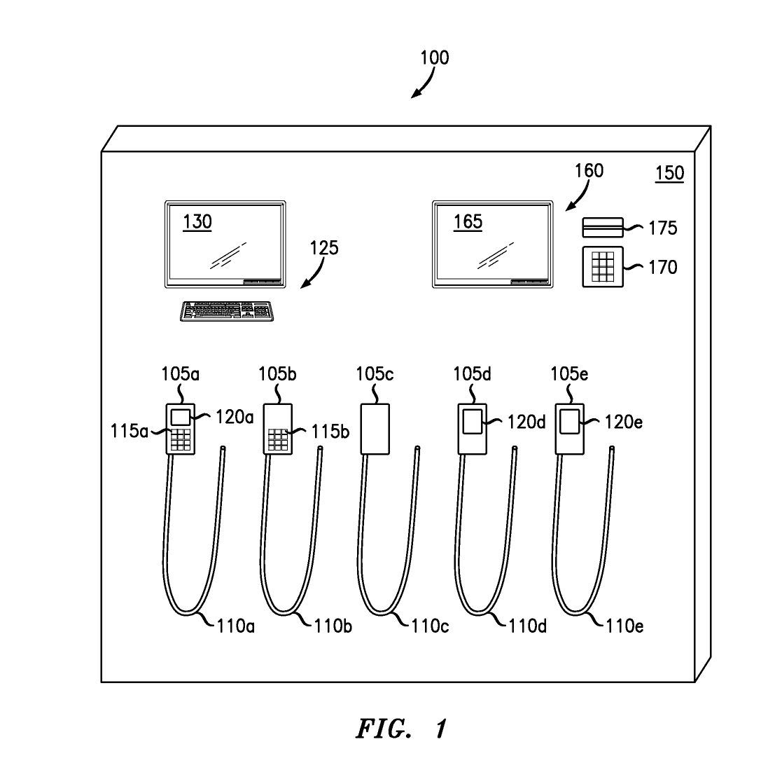

The present invention is directed to a manner of providing a telephony station, or kiosk, to permit the offering of effective communications services in a non-traditional environment. An advantageous implementation of embodiments of the invention involves making telephony services available for a number of users at more or less the same central location. The kiosk configuration proposed preferably permits ease of control and accounting by the kiosk operator as well as station security and in some cases portability. One example of such a kiosk is shown in FIG. 1.

FIG. 1 is an elevation view illustrating a telephony kiosk 100 according to an embodiment of the present invention. In other words, FIG. 1 generally illustrates one side of kiosk 100 and for purposes of illustration shows several kiosk features that in other implementations may be positioned elsewhere on the structure. The same is true of, course, of the size, shape and position of each of the features depicted. In addition, not all of the features are present at all in every embodiment, and in some embodiments other features may be added.

In the embodiment of FIG. 1, kiosk 100 includes a plurality of handsets 105a through 105e. For purposes of illustration they differ somewhat from each other, but that will not be the case in most expected implementations. In most embodiments, each handset includes a microphone and speaker (not shown) for voice communications, and in most implementations voice communication is expected to be the primary use of the kiosk. As an example, however, handset 105e may be configured with only a touch-screen display 120e and used only for applications such as text and email communication.

The other handsets of FIG. 1 are exemplary of other possible configurations. Handset 105c includes only a microphone and speaker (which, again, are not shown in FIG. 1), while handset 105b also includes a keypad 115b for dialing, texting, entering accounting information and so forth. Handset 105a includes a keypad 115a as well as a small display 120a, which may be used for displaying, for example, caller-id information or text messages. Finally, handset 105d includes a touch-screen display 120d as well as a microphone and speaker (not shown) for voice communications.

In the embodiment of FIG. 1, each of the handsets is connected by a respective cord 110a through 110e. This cord is or includes a communication cable that is preferably a coaxial cable (not separately shown). The cords 110a through 110e are therefore in this embodiment used for both communication and security. For this reason, it is also preferred that they are secured to both the handset structure and the kiosk cabinet 150 in addition to the electrical connections that must be made for communication. Although standard coaxial cable is relatively strong, the cords may also include extra reinforcing for added security.

The extra security, of course, is preferred so that the handsets are not removed from the kiosk. In a preferred embodiment, they also are not functional as standalone communication devices and the motivation for theft is thereby reduced. In some embodiments, the handsets 105a through 105e are equipped only with those components necessary to send and receive carry user communications to other kiosk components in cabinet 150.

That having been said, in some embodiments it is also preferred that the handsets are relatively easily replaceable by the kiosk operator, for example for an upgrade or because a handset has been broken. In other implementations, handsets of varying capabilities may be switched in an out as needed. The handset may be replaced along with its respective cord, which may be securely anchored but detachable from inside the kiosk cabinet 150.

The handsets may in some embodiments communicate with the kiosk components located within the kiosk cabinet 150 (not shown in FIG. 1) via a short-range wireless protocol such as Bluetooth. This may be useful, for example, where the highest levels of security are not required. Users would be permitted to range further from the kiosk cabinet 150 and some privacy may be afforded. Of course, even when a short-range radio protocol is used a security tether cord may be employed to prevent theft or inadvertent loss of the handsets. In general, the short-range radio communication for the handsets is not preferred.

In the embodiment of FIG. 1, there is also shown an operator interface 125 including a display screen 130 and a keyboard 135. The keyboard is not required of course, and a touch-screen or other input device may also be used. Operator interface 125 permits an operator to track station use, both current and historical, from the location of the kiosk 100 itself, and to perform on-site maintenance and modification work. Operator interface 125 is shown in FIG. 1 next to user interface 160, but this proximity is not required. In some embodiments operator interface 125 is located on a different side of the kiosk cabinet 150, and may be enclosed to make it more difficult to confuse for a user interface or for security reasons. In some embodiments, an operator interface may for example be located elsewhere and communicate with the kiosk 100 via a telephone system or other network connection. In some embodiments, the operator interface function may be split between several components, for example where a billing module of kiosk 100 communicates with a billing system also maintained by the operator.

In the embodiment of FIG. 1, user interface 160 is provided for users to initiate communication sessions using one an available handset of kiosk 100. User interface 160 includes a display screen 165, a keypad 170, and a payment card/token reader 175. In operation, a user may approach user interface 160, initiate a session, and choose or be assigned a handset. The user may elect a payment method and make payment either using a payment card/token or by some other access to a credit or debit account system. In some embodiments, a cash acceptor (not shown) may also be present. In other embodiments, they may be directed to a human operator to make or arrange payment.

In this regard it is noted that user interface 160 is not a requirement in all embodiments, for example where arrangements with a human operator are made and the necessary initiation handled manually. When present, user interface may have only some of the components illustrated in FIG. 1, and others not depicted may be present as well. In some embodiments, the user interface 160 and the operator interface 125 may be combined, preferably with appropriate security measures in place to prevent users from performing management functions. In still other embodiments, a user interface may be provided on some or each of the handsets 105a through 105e themselves.

In operation, a user approaches the kiosk 100 and initiates use of one of the handsets for a communication session, arranges for payment, if any, required at that time, and begins and ends the communication session.

As mentioned above, the handsets available for users preferably include minimal components in order to reduce their cost and discourage theft. The minimal-component configuration is, of course, not required in all embodiments. These minimal components include those necessary to transmit and receive user communications between the handset and the kiosk 100 internal components. The internal components will now be described in more detail.

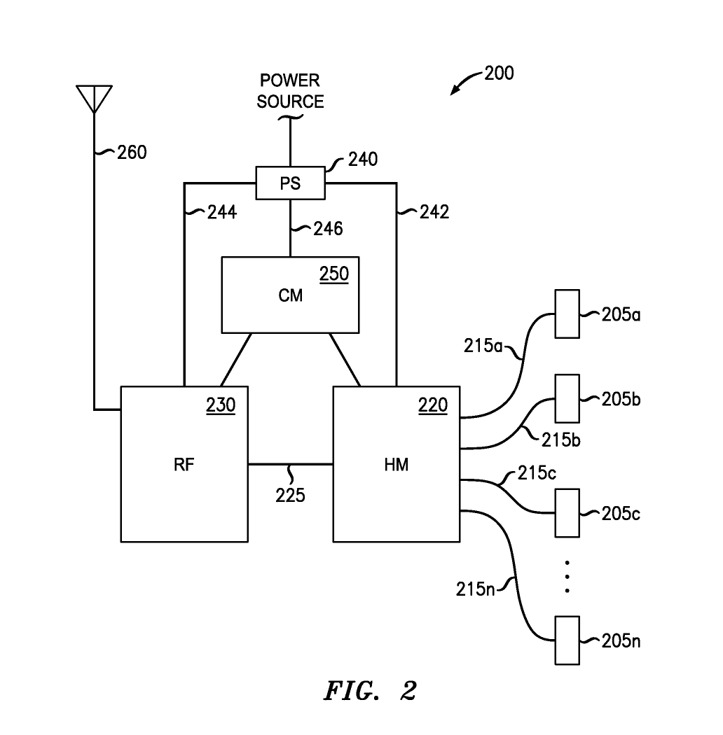

FIG. 2 is a simplified schematic diagram illustrating selected components of a telephony kiosk 200 according to an embodiment of the present invention. It is noted that telephony kiosk 200 is similar but not necessarily identical in configuration to the telephony kiosk 100 shown in FIG. 1. In the embodiment of FIG. 2, telephony kiosk 200 includes a plurality of handsets 205a through 205n. As implied by the ellipsis, there could be any number of handsets associated with kiosk 200, and the number may change over time as handsets are added or removed in accordance with need, availability, performance/capacity, and so forth. While there could be any number of handsets, in an actual implementation there may be practical limits of physical space, cost, and the ability of the other components to handle simultaneous communication sessions.

In this embodiment, the handsets 205a through 205n are assumed to include a user interface (see, for example, the various interfaces shown in FIG. 1), and a transmitter (also not shown in FIG. 2) operable to carry user communications to the components in the kiosk cabinet (see FIG. 1). In a preferred embodiment, for example, each handset includes a codec and a baseband processor (analog or digital or both) and is connected to the kiosk cabinet or the components therein by a coax cable for carrying the baseband signals.

More specifically, in this embodiment each of handsets is connected to a handset manager 220 residing in a kiosk cabinet via a respective one of cords 215a through 215n. As mentioned above, for added security the cords 215a through 215n may also be physically secured to cabinet structure (see FIG. 1). The handset manager 220 includes the physical apparatus that terminate the cords 215a through 215n and makes the necessary connections to the RF module 230. Note that in some embodiments the handset manager need not be a separate component from the RF module, but may be integrated therein. When they are separate components, as shown in FIG. 2, a connector 225, for example a ribbon cable, is present so that communications may be passed back and forth between them. Note also that while a number of the components described above are indicated to reside inside a kiosk cabinet, which is generally preferred, there is no requirement that they are so situated, or even that there is a cabinet structure present, unless explicitly recited in a particular embodiment or evident from the context.

In this embodiment, the handset manager 220 is also connected to power supply 240 via a power cord 242 and supplies power to each of the handsets 205a through 205n. Note that by supplying power to the handsets the hardware module 220 may also determine which handsets are operational. In some embodiments handsets are only made operational after some time of user authorization is provided. In this embodiment, handset manager 220 therefore provides an RF channel bridge for communications between the handsets 205a through 205n and the control module 250, and a power bridge between the power supply 240 and the handsets 205a through 205n.

In the embodiment of FIG. 2, controller module 250 includes a processor (not shown in FIG. 2) that controls operation of the handset manager 220 and the RF module 230. Through handset manager 220 it may also control the operation of the handsets 205a though 205n themselves. Controller module 250 in this embodiment also tracks handset usage for metering and billing purposes. In a similar manner handset module also monitors the time that each handset is in use for billing purposes. Power supply 240 also supplies power to control module 250 (via power cord 246) and to RF module 230 (via power cord 246).

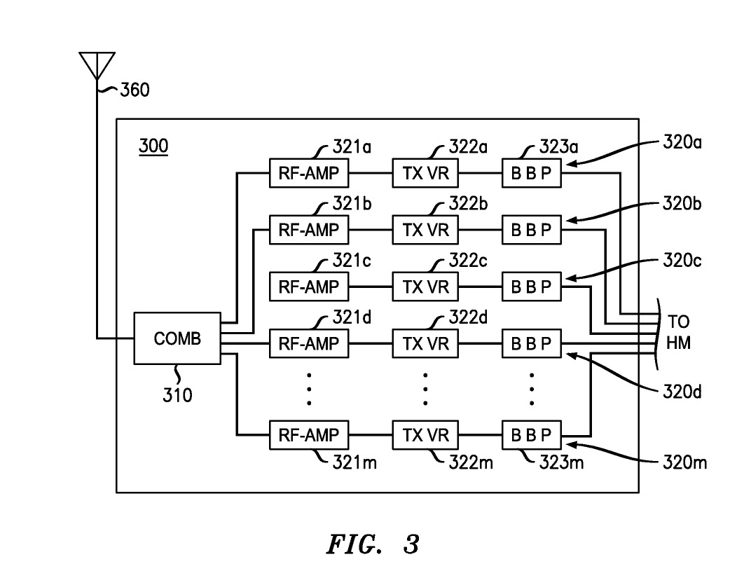

Antenna 260 is connected to RF module 230 and handles communications from the kiosk 200 to a wireless access network (not shown). RF module 230 manages the communications between the handsets 205a through 205n, as described in reference to FIG. 3. FIG. 3 is a simplified schematic diagram illustrating selected components of an RF module 300 according to an embodiment of the present invention. In this embodiment, RF module 300 includes a plurality of RF chains 320a through 320m. As implied by the ellipsis, there could be any number of RF chains, but preferably there is one for each functioning handset. This may of course include an RF chain for accommodating handsets that happen not to be used or installed in a particular implementation (but which may be added if needed).

In the embodiment of FIG. 3, each of the RF chains 320a though 320m include a baseband processor (BBP), referred to as 323a through 323m. As mentioned above, in a preferred embodiment Each RF chain also includes transceiver (TXVR) circuitry 322a through 322m for modulating outgoing transmissions from baseband to RF and for processing incoming transmissions from RF to baseband for transmission to the handsets via the handset manager (not shown). An RF amplifier 321a through 321m amplifies the RF signal for transmission on antenna 360.

In the embodiment of FIG. 3, combiner 310 receives the amplified RF signals from RF amplifiers 321a through 321m and collectively passes them to the antenna 360 for transmission, for example on a single coax cable (not separately shown). In this embodiment, it is presumed that each of the RF chains 320a through 320m selects a frequency appropriate to the combining Note that the number of RF chains present in a given implementation is a function of the number of signals that may be combined on a signal antenna. Note also, however, that the use of additional appropriately spaced antennae would increase this number, and in some embodiments other multiplexing schemes may be employed to increase capacity.

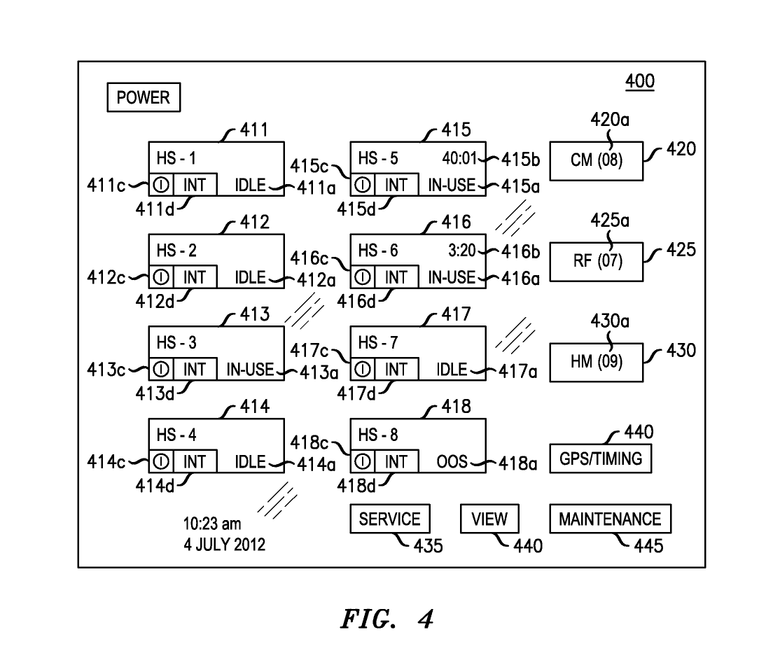

FIG. 4 illustrates an exemplary view of a touch screen 400 for monitoring the status of selected components according to an embodiment of the present invention. As mentioned above, a visible operator interface is optional but preferred in most implementations, and where employed may be mounted on the kiosk cabinet or in another, even remote location. Of course, although a touch screen is preferred, a keyboard or pointing device (such as a mouse) may also be used.

In the embodiment of FIG. 4, the touch screen 400 displays an indicator 411 through 418 showing the status of each of the handsets, in this case as in-use, idle, or out-of-service (OOS). For the handsets that are in use, an elapsed time indication 413b, 415b, 416b for the communication session is shown, In some other implementations, the time remaining for a time-limited communication session may also or instead be shown (the session may terminate automatically or simply alert the operator that time has expired, permitting some discretion). Here, buttons 411c through 418c are provided to activate or deactivate a particular handset, and 411 d through 418d to initiate or terminate communication directly with the user of a handset in “intercom” (INT) mode.

In the embodiment of FIG. 4 the status of the kiosk modules, the handset manager (430), the control module (420), the RF module (425), and the GPS receiver (440) is also shown. Each of these indicators should have a display representation to show whether a given module is fully or partially operational. Depicted in this embodiment are fully active entity counts 420a, 425a, 430a showing the status of each in the respective components. In other embodiments (not shown), such status presentation is not limited to counts and can be represented in any convenient manner such as a “temperature bar” showing whether a given module is fully or partially operational. Though not shown in FIG. 4, it is desirable to provide to the operator the ability to display more detailed information about a particular component by touching or otherwise activating a particular indicator.

Finally, in this embodiment commands or pull-down menus are activated using operation buttons 435, 440, 445, and a power indicator 455 and the time and date 450 are displayed. Note that the configuration of FIG. 4 is exemplary and many others are possible. The various indicators preferably use a color code (for example, green for active, blue for inactive, or red for out-of-service) to indicate or highlight the indication of a particular status condition.

The various components of the present invention may be implemented in a number of different configurations. In a preferred embodiment, the three major components, the handset manager, the RF module, and the control module are integrated into a single physical entity that is field replaceable. Note, however, that this single entity may take a number of forms, for example a removable card, a printed circuit board, or a cabinet or chassis.

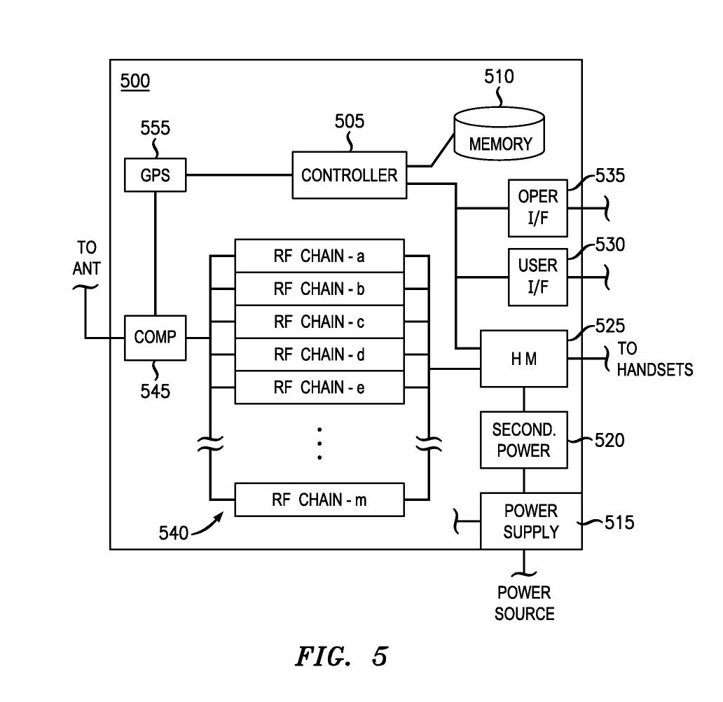

FIG. 5 is a block diagram illustrating selected components of an integrated kiosk module 500 according to an embodiment of the present invention. The kiosk module 500 of FIG. 5 includes a controller for controlling the operation of the other components of kiosk module 500 and handling the call accounting function in accordance with program instructions stored on memory device 510. Memory device 510 is a non-transitory device capable of storing program instructions, for example a flash memory RAM (random access memory).

Memory device 510 also includes an accounting database (not separately shown) to store accounting information related to communication sessions of users and the accounting rules that should be applied to them. Note, however, that he accounting module need not be present in all embodiments—in some implementations the user will simply pre-pay and either end their session after the allotted time or be interrupted by a human operator. But automating at least some of the process with an accounting tool is generally preferred.

Communicating with the user may be performed entirely via a handset, but as was mentioned in reference to FIG. 1 a separate user interface may also be provided (for example user interface 160). In the embodiment of FIG. 5, a user interface module 530 is provided for this reason. Similarly, operator interface module 535 is provided on kiosk module 500 for interfacing with an operator interface such as operator interface 125 shown in FIG. 1. It is noted again that both of these interfaces are optional though desirable in many implementations.

Returning to the embodiment of FIG. 5, handset manager 525 interfaces with the handsets (not shown) of the kiosk as described above. Note that while for convenience only a single communication line is shown, there is generally a cord associated with each handset unless a wireless access point is being employed. In any event, handset manager 525 provides a bridge between the handsets and the RF module 545. In this embodiment, it also provides power to the handsets, typically through the cords themselves. Secondary power management module 520 receives power, in this case, from primary power supply 515, which in turn is connected to a power source. Power supply 515 also supplies power to some or all of the other components of kiosk module 500.

The power source may be external or internal to the kiosk itself. Often, of course, electric power may be supplied from the local grid, perhaps through a private electrical system. In many implementations, however, power may be supplied or supplemented by an on-board fuel cell, generator, solar panel or wind turbine. A battery backup may also be advantageous in some circumstances. In some embodiments, batteries may also be used for power in the handsets, which need then not rely on power supplied from the kiosk cabinet. In this is not preferred, however, due to cost and security considerations, but in some implementations it may be useful.

Returning to the embodiment of FIG. 5, RF module includes a number of RF chains referred to as RF Chain-A through RF Chain-M. Again, there may be any number of such RF chains, subject to practical limitations, and preferably one for each handset that is or may be deployed with the kiosk. Note that a particular RF chain is not necessarily statically associated with a particular handset. In some embodiments, the handset manager will assign an RF chain whenever a communication session is about to begin, and switch the connections appropriately. Signals modulated in the RF chains are combined in combiner 545 for transmission on a single antenna. Again, multiple antennae may be used instead but this is not preferred. Combiner 545 also acts to provide received signals for each of the RF chains.

In the embodiment of FIG. 5, a GPS unit 555 is also present and connected to the antenna via the combiner 545. GPS unit 555 receives and processes GPS transmissions for RF signal processing stability, and to determine position information, especially useful if the kiosk is a portable unit.

Note that the configuration in FIG. 5 is exemplary and there may be additional, or in some cases, fewer components present in a given embodiment.

In operation, the telephony kiosk of the present invention provides a communication facility that may be used by a number of users who for one reason or another cannot or do not wish to employ a personal communication device. The user approaches the kiosk and determines if there is an available handset. They may then arrange for its use by speaking with a human operator, who may be on site or remote, using the handset itself or a separate user interface, such as one mounted in the kiosk cabinet. A human operator may not always be employed; the user may also interact with the kiosk controller module or other authorization agent via a user interface.

In preferred embodiments, the reason for this user interaction with the telephony kiosk is authorization. (In some cases, communication services are simply provided for users, such as at an industry meeting or military installation, or in an emergency situation where other communications are for some reason not available or desirable.) The authorization presumably comes after arrangements for whatever method of payment is used are made. This may be, for example, a cash payment made in advance or credit extended. There may also be ‘subscribers’ who are billed on a regular basis at a flat rate or based on usage.

In the preferred embodiment once the authorization takes place, a handset is activated, for example by energizing or linking an already powered handset to an RF chain in the RF module. The communication session ends when the user indicates that they are finished or at a time determined by the kiosk or the human operator. In some cases, communication sessions are interrupted or placed on hold for negotiating further payment arrangements. In this embodiment, when the communication session has terminated, the handset is disconnected from the RF chain so that it may not be used for communications other than with the kiosk or kiosk operator.

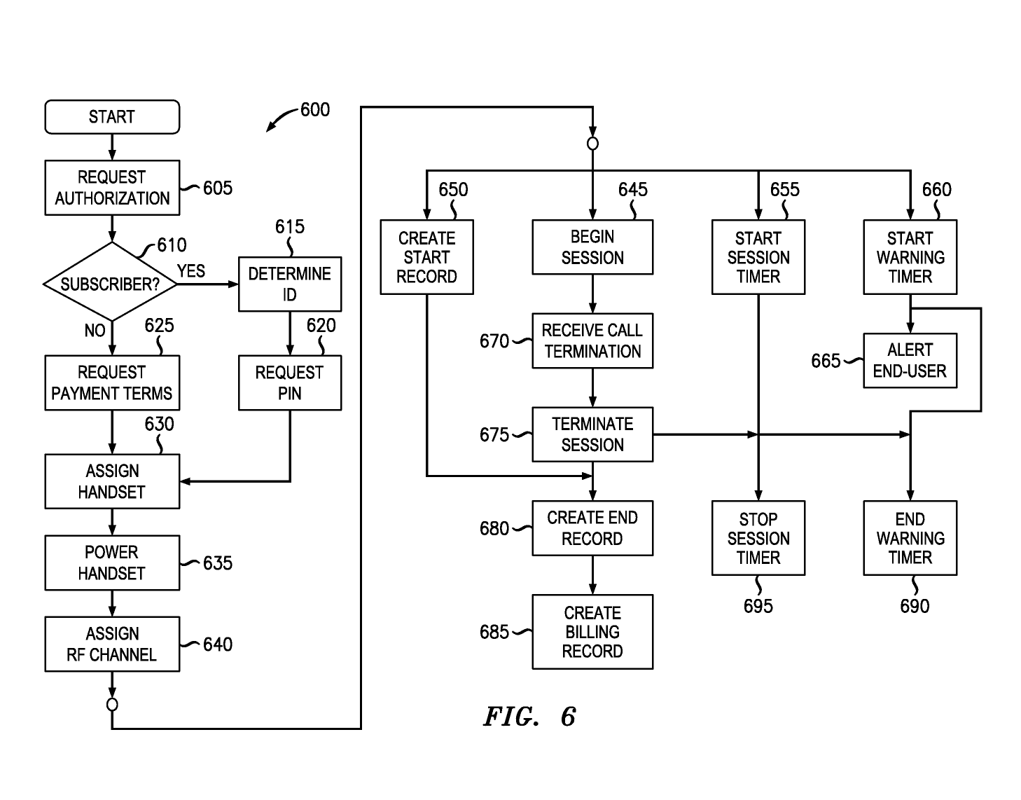

FIG. 6 is a flow diagram illustrating a method 600 according to an embodiment of the present invention. At START it is presumed that the components for performing the method are available and operational according to the embodiment of method 600. The process then begins when the kiosk receives a request for authorization (step 605). As mentioned above, this request may take a variety of forms. In this embodiment, it is assumed that the kiosk, at least in the first instance, handles the authorization without the need to involve a human operator. The user is then queried (step 610) via a user interface whether they are a subscriber. If so, they are queried (step 615) to determine their identity. Identification may take a number of forms, such as the scanning of an ID card magnetic strip or bar code. Upon receiving this input, the kiosk confirms that they are in fact a subscriber by reference to an internal or offsite database. Assuming that they are a subscriber, they may be asked to confirm (step 620) their identity by typing a PIN number, answering a security question, or by a similar method.

In this embodiment, it is presumed that for subscribers, payment terms are already arranged or, as may be the case in some implementations, no payment is required so long as the user is a subscriber (for example, an employee of the company providing the kiosk).

In this embodiment, if the kiosk receives an indication that the user is not a subscriber, then a request to complete payment terms is made (step 625). Here, the user may be offered a rate schedule and asked to provide a credit card or cash payment in advance, or make other arrangements if they are available.

In either case, if satisfactory identity and payment-term confirmation are not possible, the user in this embodiment may request to speak via the user interface with a human operator (not shown). Of course, where this is available if the necessary conditions are satisfied the operator may override the other authentication and payment processes. If no satisfactory arrangement may be made, the user is simply not allowed to begin a communication session.

In the embodiment of FIG. 6, when the identification and any necessary payment terms have been satisfied, the user is assigned a handset (step 630), and the handset is powered up (step 635) and linked by a handset manager (step 640) to an operational RF chain in the RF module. Note that while these steps are required in this embodiment, in others (not shown) they may not be. For example the user may be communicating with the kiosk via a powered handset, and upon authorization all that remains is to link the handset to an RF chain. Here it is noted that other ways to lock out the handset or its associated RF chain are possible and may be used in other embodiments.

Once a powered an operational communication channel is established, the communication session may begin (step 645). In this embodiment, at this point the control module creates a record (step 650) in an accounting database indicating the start of the session and, if applicable, its anticipated duration (for example, for a prepaid call).

In this embodiment, a session timer may be set (step 655) to terminate the session when the anticipated duration has been reached. In some implementations, this automatic termination may be applied to all users, even subscribers, for example where heavy traffic requires that all coals be limited in duration. A warning timer may also be set (step 660) to alert the user that a certain amount of time has elapsed since the communication session began. At the appropriate time an alert is sent (step 665) to the user. The alert may indicate the session will end absent some additional payment, for example, or simply let a credit customer or subscriber know that a certain amount of time or expense has already accrued. More than one such alert may be sent in a communications session. Generally speaking, it is preferable to provide one or more warnings prior to termination by the session timer (not shown).

In this embodiment, it is presumed that the session timer, if any, has not expired, but rather that the user simply finishes their call. When the kiosk receives an indication (step 670) that the user has ended the call, for example by pressing a button on the handset, the communication session is terminated (step 675). When this occurs, a record is created (step 680) in the accounting database indicating when the session has been closed. In some embodiments, a billing record is then created (step 685), if appropriate. Billing records are created, for example, for the purpose of securing payment from a credit card company or simply to track kiosk usage. The kiosk may display or print a record (not shown) for the user indicating the duration of the call or the cost, or both. In most embodiments, at termination the handset may be powered down and disconnected (not separately shown) depending on the state the operator chooses to leave the handsets in post-session. If necessary, the session timer (step 695) and the warning timer (step 690) may also be stopped after session termination at step 675.

Note that the sequence of operation illustrated in FIG. 6 represents an exemplary embodiment; some variation is possible within the spirit of the invention. For example, additional operations may be added to those shown in FIG. 6, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A telephony kiosk, comprising:
an RF (radio frequency) module comprising a plurality of RF chains, each RF chain including a transceiver for modulating a signal received from a handset that has been associated with the RF chain; and
a controller for controlling the operation of the RF module.

2. The telephony kiosk of claim 1, further comprising a combiner for combining modulated signals from more than one RF chain of the plurality of RF chains for transmission using a single antenna.

3. The telephony kiosk of claim 1, further comprising an antenna.

4. The telephony kiosk of claim 1, further comprising a handset manager for connecting to one or more handsets and bridging communications between a respective handset and an associated RF chain.

5. The telephony kiosk of claim 4, wherein the handset manager selectively bridges the communications between a handset and an RF chain as directed by the controller.

6. The telephony kiosk of claim 1, further comprising a plurality of handsets.

7. The telephony kiosk of claim 1, further comprising a memory device in communication with the controller for storing control programs for execution by the controller.

8. The telephony kiosk of claim 7, further comprising an accounting module for recording information related to communication sessions conducted using the RF module.

9. A telephony kiosk, comprising:
a plurality of handsets;
an RF module comprising a plurality of RF chains, each RF chain including a transceiver for modulating a signal received from a handset of the plurality of handsets;
a handset manager for associating a handset of the plurality of handsets with an RF chain of the RF module; and
a controller for directing the RF module.

10. The telephony kiosk of claim 9, further comprising at least one antenna in communication with the RF module for transmitting and receiving RF communications.

11. The telephony kiosk of claim 9, further comprising at least one user interface.

12. The telephony kiosk of claim 9, further comprising an operator interface.

13. The telephony kiosk of claim 9, further comprising a cabinet for housing the RF module and the controller.

14. A method of providing telephony services to the user of a telephony kiosk, comprising:
assigning a handset to the user;
bridging communications to and from the handset to an RF chain in an RF module of the kiosk; and
transmitting communications from the handset to a communications network as an RF signal.

15. The method of claim 14, further comprising authorizing the user prior to assigning a handset.

16. The method of claim 15, further comprising providing power to the handset subsequent to authorizing the user.

17. The method of claim 14 further comprising selecting an RF chain from a plurality of RF chains in the RF module for associating with the handset.

18. The method of claim 14, further comprising creating a billing record for the use of the handset by the user.
